(19) United States
(12) Patent Application Publication
(10) Pub. No.: US 2018/0218410 A1
(43) Pub. Date: Aug. 2, 2018

(54) USER-LEVEL BIDDING FOR ADVERTISING CAMPAIGNS

(71) Applicant: Facebook, Inc., Menlo Park, CA (US)

(72) Inventors: Ramnik Arora, Palo Alto, CA (US); Kurt Dodge Runke, Los Altos, CA (US)

(21) Appl. No.: 15/421,397

(22) Filed: Jan. 31, 2017

(51) Int. Cl. G06Q 30/02

(52) U.S. Cl. CPC G06Q 30/0275; G06Q 30/0242; G06Q 30/0267; G06Q 30/0277

(57) ABSTRACT

An online system presents ads on behalf of advertisers to users of the online system. For an ad campaign, the online system determines bid prices to be associated with an ad for different eligible users based at least on user cost models associated with the eligible users and a value curve that specifies an amount of value the advertiser derives from each ad impression. Using user cost models and the value curve, the online system evaluates how much value an advertiser will derive from ad impressions. The online system maximizes an expected value that an advertiser can derive from ad impressions to an eligible user to determine a bid price. The online system calculates an expected value as an amount of value that the advertiser derives from the ad impression with a bid price weighted by a likelihood of winning auctions with a bid price.

### BACKGROUND

### 1. Field of Art

This disclosure relates generally to online advertising, and more specifically to user-level bidding for advertising campaigns.

### 1. Description of the Related Art

Advertisers may have certain goals when planning a new advertising campaign (“ad campaign”). For instance, an advertiser may have a goal for the number of times an advertisement (“ad”) is presented to users of an online system (i.e., the number of “impressions” of the ad), the number of different online system users presented with an ad (i.e., the “reach” of the ad), and/or a duration during which the ad is presented. Conventionally, an advertiser may specify certain attributes of an advertising campaign or ads in an advertising campaign when specifying the advertising campaign. For example, an advertiser may identify targeting criteria associated with one or more ads in an advertising campaign and bid prices associated with various ads in the advertising campaign.

Additionally, an advertiser may specify a time limit or duration for the advertising campaign. The time limit stops the presentation of ads in the advertising campaign after the time limit expires, even if the budget of the advertising campaign has not been exhausted. In other examples, the time limit for an advertising campaign represents a target date by which to spend the budget. Hence, the advertising campaign may be presented to users either until the budget is exhausted or the time limit expires. Particularly for advertising campaigns with low budgets, ads from the advertising campaigns may cease to be presented to users of an online system before the time limit of the advertising campaign expires.

Conventionally, to minimize cost per thousand impressions (CPM) and to maximize a number of impressions under the budget of an advertising campaign, advertisements may be targeted to a large audience, and actually reach those users among the audience that are less expensive to reach. This is because costs to present an advertisement to different audiences and different users within a given audience can vary significantly. For example, it typically costs more to reach users in more developed areas than less developed areas. As another example, it typically costs more to reach users who spend less time online shopping than users who spend more time online shopping. However, advertisers also derive different values from different audiences. When an ad is presented to users that cost less to reach multiple times and thus fail to reach users that cost more to minimize the CPM across users, the value derived by an advertiser from ad presentation may be diminished. Accordingly, advertisers cannot always receive maximum values from the budget allocated to an advertising campaign.

### SUMMARY

An online system presents ads of ad campaigns on behalf of advertisers to users of the online system. The ad campaign specifies one or more other delivery parameters such as a budget, a time interval, a target reach amount, a target impression amount, and users who are eligible to receive an advertisement of the ad campaign (i.e., those users targeted by the ad campaign). For an ad campaign, the online system determines different bid prices for different eligible users. The bid price for that ad campaign for a given user specifies an amount of compensation an advertiser providing an ad campaign will offer to compete with other advertisers for presenting an ad to that user. To determine an optimized bid for a user, the online system evaluates how much value an advertiser will derive from ad impressions to the user by estimating the number of times the advertisement may actually be presented to users at given bid prices. To determine the number of times an advertisement may actually be presented, a user cost model for the user is determined that includes a distribution of bid prices associated with ads that have been presented to the user. That is, the user cost model identifies the distribution of historical costs to present advertisements to the user. These historical costs are determined by using winning bids for prior auctions for the particular user. The online system creates and updates user cost models. From the user cost model, for a given bid price, a likelihood of winning an auction and the number of times winning ad auctions can be determined. For a given bid price, the number of times winning ad auctions may also be determined. Accordingly, the estimated value for the bid price is determined by summing the value of the number of times winning ad auctions weighted by the probability of winning ad auctions for the number of times (i.e., times that the advertisement is presented). For example, at a given bid price, there may be a 10% likelihood of zero impressions, 25% likelihood of 1 impression, 50% likelihood of 2 impressions, and 15% likelihood of 3 impressions.

The value of presenting advertisements to users may be represented by a value curve specifying a value amount for each sequential presentation of an advertisement to a particular user. Thus, a first impression of an advertisement to a user may be the most valuable, while a second impression may be less valuable than the first, and a third impression may be less valuable than the second. In one embodiment, the value curve has a specified value amount for first impressions, termed a “reach value” that reflects the value of presenting the advertisement to a user for the first time, and a set of “non-reach values” that reflect additional presentations of the advertisement to the user. In this example, the non-reach value is constant in the value curve for one or more impressions until a maximum number of impressions, at which point the value for additional impressions may be treated as zero. This maximum number of impressions may also be termed a “frequency cap” for presenting the advertisement.

Using the value curve and bid value for each user, a spending rate, reach (number of users receiving the advertisement) and total number of impressions can be determined. Based on a desired combination of these for the campaign, the value curve may be adjusted (e.g., by modifying the reach value or the non-reach value) to determine a new per-user bid and estimated results of the campaign. As one example, an estimated budget for the campaign based on an initial value curve may exceed the desired budget for the campaign and not reach as many users are desired by the campaign. To reduce the budget and reach more new users, the value curve can be adjusted to increase the reach value and/or decrease the non-reach value. As another example, the prior spending and the estimated spending rate for the campaign may be used to automatically pace spending during the campaign. As one example, the non-reach value may be increased or decreased to adjust the spending rate of the campaign. Since the bid amount is selected on a per-user basis, the actual spending of a campaign can be efficiently optimized for the desired combination of estimated budget/spending, reach, and impressions.

### BRIEF DESCRIPTION OF THE DRAWINGS

FIG. 1 is a block diagram of system environment 100 for performing user-level advertising bidding, according to one embodiment.

FIG. 2 is a block diagram of an online system, according to one embodiment.

FIG. 3 is a block diagram of an example advertisement module, according to one embodiment.

FIG. 4A illustrates an example user cost model, according to one embodiment.

FIG. 4B illustrates an example value curve, according to one embodiment.

FIG. 5 is a flowchart of a method for determining bid prices based at least on user cost models for presenting ads from an ad campaign, according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Overview

FIG. 1 is a block diagram of system environment 100 for performing user-level advertising bidding. System environment 100 shown by FIG. 1 comprises one or more client devices 110, one or more third-party systems 130, an online system 140, and a network 150. In alternative configurations, different and/or additional components may be included in the system environment 100. The embodiments described herein can be adapted to online systems that are not online systems.

The client device 110 is a computing device capable of receiving user input as well as transmitting and/or receiving data via the network 150. A client device 110 is a device having computer functionality, such as a smartphone, personal digital assistant (PDA), a mobile telephone, or another suitable device. A client device 110 is configured to communicate via the network 150. In one embodiment, a client device 110 executes an application allowing a user of the client device 110 to interact with the online system 140. For example, a client device 110 executes a browser application to enable interaction between the client device 110 and the online system 140 via the network 150. In another embodiment, a client device 110 interacts with the online system 140 through an application programming interface (API) running on a native operating system of the client device 110, such as IOS® or ANDROID™. The client device 110 also includes a user interface 120 that allows a user to interact with the client device 110. Via the user interface 120, a user can further interact with the online system 140. The client device 110 can execute an application associated with the online system 140 and present the user interface 120 based on information received from the online system 140.

One or more third party systems 130 may be coupled to the network 150 for communicating with the online system 140. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as ads, content, or information about an application provided by the third party system 130.

The network 150 includes any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

The online system 140 includes a computing environment that allows users of the online system 140 to communicate or otherwise interact with each other and access content. In addition, the online system 140 provides advertising services for advertisers. For example, the online system 140 receives an advertising campaign (“ad campaign) from an advertiser, that includes one or more advertisements (“ads”) for presentation to users of the online system 140. The ad campaign may be received from a third party system 130 or may be maintained by the online system 140. The online system 140 presents ads on behalf of advertisers to users of the online system 140 according to the advertisers' requirement to meet the advertisers' goals as further described below.

### Online System

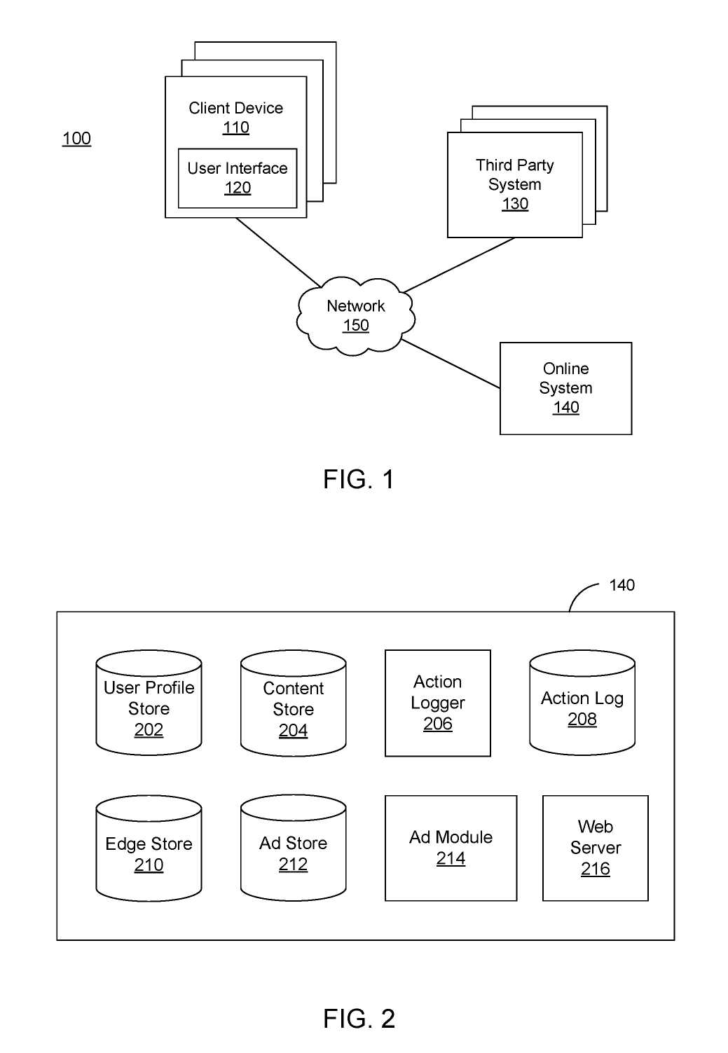

FIG. 2 is a block diagram of a system architecture of the online system 140, according to one embodiment. The online system 140 shown in FIG. 2 includes a user profile store 202, a content store 204, an action logger 206, an action log 208, an edge store 210, an advertisement (“ad”) store 212, an ad module 214, and a web server 216. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 202. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 202 may also maintain references to actions by the corresponding user performed on content items in the content store 204 and stored in the action log 208.

While user profiles in the user profile store 202 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 204 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 204, such as status updates, photos tagged by users to be associated with other objects in the online system, events, groups or applications. In some embodiments, objects are received from third-party applications or third-party applications separate from the online system 204. In one embodiment, objects in the content store 204 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 206 receives communications about user actions internal to and/or external to the online system 140, populating the action log 208 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 208.

The action log 208 may be used by the online system 140 to track user actions on the online system 140, as well as actions on third party systems 130 that communicate information to the online system 140. Users may interact with various objects on the online system 140, and information describing these interactions is stored in the action log 208. Examples of interactions with objects include: commenting on posts, sharing links, checking-in to physical locations via a mobile device, accessing content items, and any other suitable interactions. Additional examples of interactions with objects on the online system 140 that are included in the action log 208 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 208 may record a user's interactions with ads on the online system 140 as well as with other applications operating on the online system 140. In some embodiments, data from the action log 208 is used to infer interests or preferences of a user, augmenting the interests included in the user's user profile and allowing a more complete understanding of user preferences.

The action log 208 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 208 may record information about actions users perform on a third party system 130, including webpage viewing histories, ads that were engaged, purchases made, and other patterns from shopping and buying.

In one embodiment, the edge store 210 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 108, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 210 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's interest for an object, interest, or other user in the online system 140 based on the actions performed by the user. Multiple interactions between a user and a specific object may be stored as a single edge in the edge store 210, in one embodiment. Alternatively, each interaction between a user and a specific object is stored as a separate edge. In some embodiments, connections between users may be stored in the user profile store 202, or the user profile store 202 may access the edge store 210 to determine connections between users.

The ad store 212 stores information associated with ad campaigns received from one or more advertisers. An ad campaign includes one or more ads for presentation to users of the online system 140. An ad includes content for presentation to users such as one or more images, video, text, audio or other types of media. In various embodiments, the ad content is associated with a network address specifying a landing page, or other destination, to which a user is directed when the ad is accessed. An ad campaign is associated with one or more delivery parameters that describe an advertiser's goal of an ad campaign as well as the advertiser's restrictions on delivery of the ad campaign. For example, an advertiser specifies a budget representing a total amount that is allocated to compensate the online system 140 for presenting ads in an ad campaign. An amount is deducted from the budget each time an ad from the ad campaign is presented and sometimes when an action associated with the ad by an advertiser occurs (e.g., an impression of an ad, a conversion event associated with the ad). When the budget is exhausted, the online system 140 stops presenting ads from the ad campaign. More example delivery parameters are further described below.

An advertiser can also associate with an ad campaign a time interval or duration during which an ad is eligible for presentation to users. The online system 140 presents the ad from the ad campaign only during the time interval. For example, if the duration is 30 days, the online system 140 presents ads from the ad campaign for 30 days or until the budget is exhausted. An advertiser can specify a start date and time for an ad campaign, and a duration is measured from the specified start date and time. An advertiser can specify a frequency cap that is a maximum number of times that an ad can be presented to a user. An advertiser can also associate with an ad campaign one or more targeting criteria describing characteristics of users to whom an ad is to be presented. An advertiser can associate with an ad campaign one or more goals or objectives. For example, an advertiser specifies an impression objective that is a total number of impressions of ads in the ad campaign, a reach objective that is a total number of unique users to whom an ad is to be presented, and a frequency objective that is a number of times an ad from the ad campaign is presented to a user of the online system 140.

In addition, an advertiser can associate with an ad campaign value that it expects to derive from the ad campaign. Advertisers derive value from ad presentation when users take certain actions as a result of ad presentation, such as clicking on an ad, registration to the advertiser's service or product, or conclusion of a sale of a service or product. An advertiser can associate with the ad campaign a value curve that specifies a value amount for each sequential presentation of an ad to a user. In one embodiment, the value curve specifies a first value amount (R) that an advertiser expects to derive from each reach impression and a second value amount (I) that it expects to derive from each non-reach impression. In other examples, more than one value is used for the non-reach impressions, such that a 3^{rd} impression of an advertisement is valued differently than the 5^{th} impression of an advertisement. As described herein, a reach impression refers to a first time that an ad is presented to a user and a non-reach impression refers to each time subsequent to the first time that an ad is presented to a user. The online system 140 can determine a first value amount from a reach impression and a second value amount from a non-reach impression using the value curve and one or more other delivery parameters such as a budget, a frequency cap, a time interval, a target impression amount, a target reach amount, and the like.

The advertisement (“ad”) module 214 presents ads on behalf of advertisers. The ad module 214 identifies a set of impression opportunities for ads from the ad campaign based on the delivery parameters associated with the ad campaign. Each impression opportunity corresponds to an opportunity to present an ad from the ad campaign to a user of the online system responsive to an ad request. The ad module 214 receives ad requests from client devices 110 for ads. For an ad campaign, the ad module 214 identifies impression opportunities when receiving ad requests from eligible users that match targeting criteria associated with the ad campaign.

For an ad campaign, the ad module 214 determines bid prices to be associated with an ad for different eligible users based at least on user cost models associated with the eligible users. A bid price specifies an amount of compensation an advertiser providing an ad campaign will pay the online system 140 for presenting the ad to a user. For advertisements that compensate the online system 140 based on actions performed by a user who receives the ad, the bid price is a conversion of a payment per-action to an expected value for providing an ad impression. Examples of actions associated with a bid price include presenting an ad to a user, receiving a user interaction with the ad, receiving a user interaction with an object associated with the ad, or any other suitable condition.

Using user cost models, the ad module 214 evaluates how much value an advertiser will derive from ad impressions to different users. The ad module 214 determines a bid price by maximizing an expected value that an advertiser can derive from presenting ads to an eligible user at the bid price by estimating the likely number of advertisements served at that bid price using the cost model. The user cost model of a user includes a distribution of bid prices associated with ads that have been presented to the user. The ad module 214 creates and updates user cost models. From the user cost model, for a given price, a likelihood of winning an ad auction and a likelihood of winning an ad auction for a number of times can be determined. The ad module 214 calculates an amount of value that an advertiser will derive as an amount of value that an advertiser derives from an ad impression with a bid price weighted by a likelihood of winning an ad auction with the bid price. The ad module 214 calculates the amount of value that the advertiser derives from the ad impression with the bid price as an excess value between a value of an ad impression and a bid price. Likewise, the ad module 214 can calculate an amount of value that an advertiser will derive from presenting the ad to a user for multiple times. Advertisers typically specify a value curve that specifies the amount of value of the ad being presented to a user sequentially.

The ad module 214 includes the ad associated with the determined bid price along with other ads and their associated bid prices in an ad auction for the impression opportunity. The ad module 214 selects one ad from the ads included in the ad auction and present the selected ad to the user corresponding to the impression opportunity. For example, the ad module 214 may rank the ads included in the auction by their associated bid prices and selects the highest ranked ad. The selection process may use a variety of auction types such as a highest-bid auction, a Vickrey-Clarke-Groves auction, and the like. The ad module 214 provides the selected ad to the client device of the user for presentation.

The web server 145 links the online system 108 via the network 106 to the one or more client devices 120, as well as to the one or more third party systems 104. The web server 145 serves web pages, as well as other content, such as JAVA®, FLASH®, XML and so forth. The web server 145 may receive and route messages between the online system 108 and the client device 120, for example, instant messages, queued messages (e.g., email), text messages, short message service (SMS) messages, or messages sent using any other suitable messaging technique. A user may send a request to the web server 145 to upload information (e.g., images or videos) that are stored in the content store 110. Additionally, the web server 145 may provide application programming interface (API) functionality to send data directly to native client device operating systems, such as IOS®, ANDROID™, WEBOS® or BlackberryOS.

### Advertisement Module

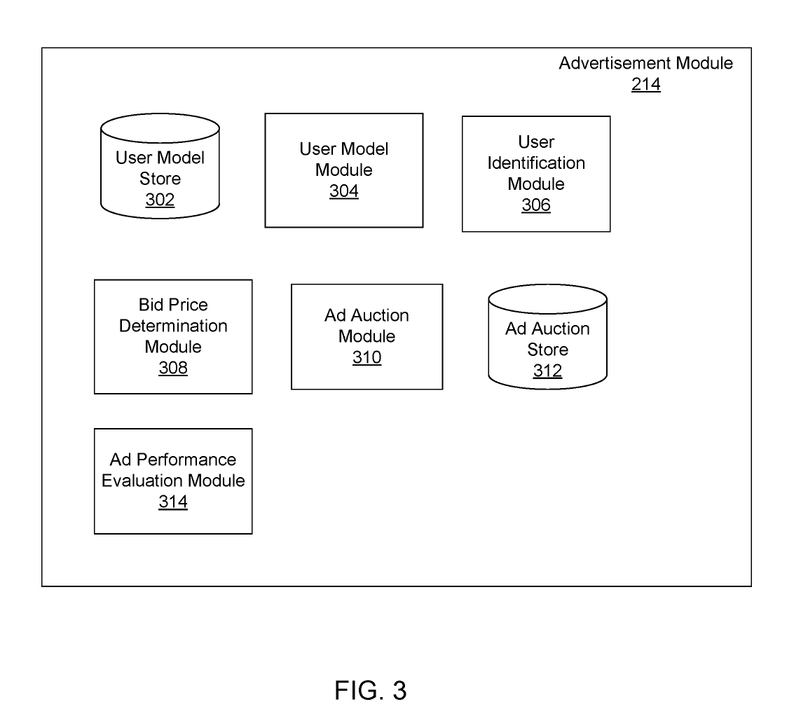

FIG. 3 is a block diagram of an example advertisement module, according to one embodiment. The advertisement module includes a user model store 302, a user model module 304, a user identification module 306, a bid price determination module 308, an ad auction module 310, an ad auction store 312, and an ad performance determination module 314.

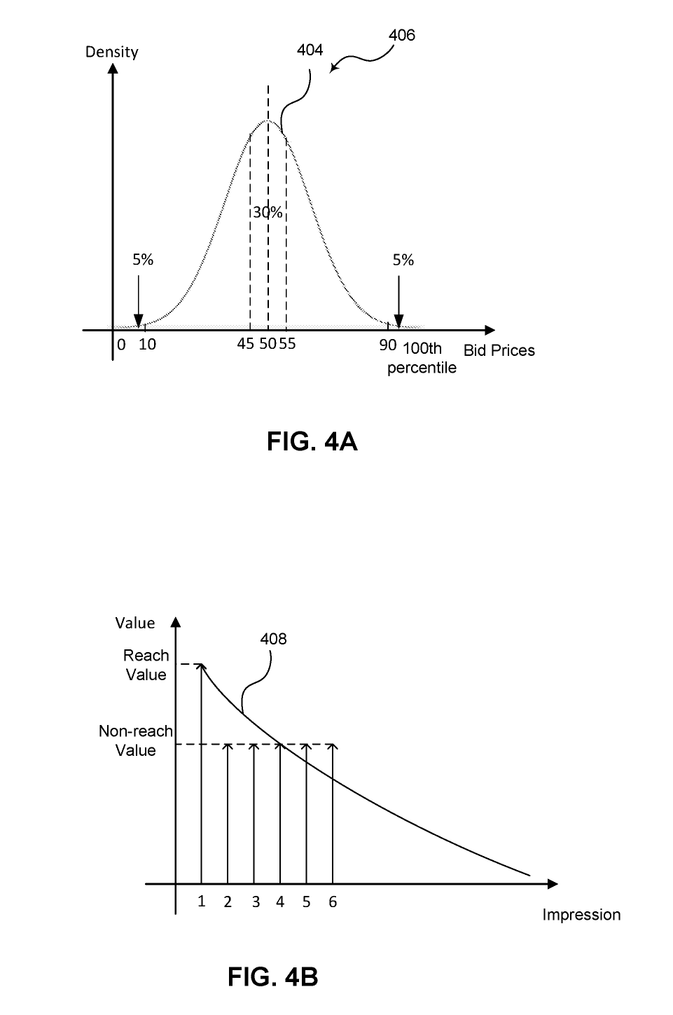

The user model store 302 stores user cost models for users of the online system 140. The user cost models are created and maintained by the user model module 304 as further described below. A user cost model for a user can be used to determine a probability of an ad that is associated with a given bid price to be presented to a user (i.e., a probability of an ad associated with a bid price winning an auction associated with an impression opportunity). A user cost model typically includes a distribution of costs to advertisers for presenting ads to the user. In some embodiments, a user cost model of a user includes a distribution of bid prices associated with ads that have been presented to the user. These may be the bid prices of campaigns that successfully placed content to the user (i.e., won the auction). Referring now to FIG. 4A, the curve 402 is an example user cost model of a user. The illustrated user cost model describes that, for this particular user, more ads are associated with bid prices around the 50th percentile than near the 0th percentile and near the 100th percentile. Among ads that have been presented to this particular user, 30% (5%, or 5%) of the total ads are associated with a bid price in the 45 to 55th (0-10th, or 90-100th) percentile range. In one embodiment, the 50th percentile bid price is an average of bid prices associated with ads that have been presented to the user. The 50th percentile may also be the mean of bid prices associated with ads that have been presented to the user.

Referring back to FIG. 3, the user model module 304 creates and maintains user cost models for users of the online system 140. For a user, the user model module 304 creates a user cost model based on information associated with ads that have been presented to the user. For example, bid prices associated with the ads that have been presented, amount charged to the advertisers providing the selected ads, other ads that compete with the selected ads in the auctions, auction prices associated with the ads that have been presented when the online system 140 subsidizes and/or penalizes advertisers, amount of subsidy (or penalty) provided by the online system 140 that are associated with the ads that have been presented, and the like. As described hereinafter, bid prices are used as examples to facilitate the description, though the cost model may be based on these other factors. One of ordinary skill in the art would appreciate that a user cost model of a user may include or describe distribution auction prices associated with ads that have been presented to the user, distribution of amount charged to advertisers associated with ads that have been presented to the user, and the like.

For each user, the user model module 304 analyzes the bid prices associated with the ads that have been presented to a user to determine a function (e.g., a probability distribution function) of the bid prices thereby to create a user cost model. Probability distribution functions can be symmetrical as illustrated in FIG. 4A or asymmetrical. Given a bid price or a range of bid prices as an input, a user cost model outputs a probability of an ad associated with the bid price or the range of bid prices is to be presented to the user. Since ads that are presented to a user are updated continuously, the user model module 304 updates the user cost model of the user in real time each time an ad is newly presented to the user. Alternatively, the user model module 304 updates the user cost model periodically using information associated with newly presented ads since the last time when the user cost model was updated.

The user identification module 306 identifies a plurality of users that are eligible to be presented with an ad of an ad campaign based on one or more targeting criteria associated with the ad campaign. An advertiser associates with the ad campaign the one or more targeting criteria identifying one or more characteristics of eligible users. As one example, an advertiser targets an ad towards females in California who have interacted with the advertiser's page in the past 180 days. The targeting criteria may identify users by their demographic information (e.g., age range, gender, education level, etc.), geographic locations, hobbies or preferences, and the like. The targeting criteria may also identifying users that having actions or types of connections with another user or object of the online system 140. The targeting criteria may also specify interactions between a user and objects performed external to the online system 140, such as on a third party system 130. The targeting criteria may further identify users having a connection or a particular type of connection with another user or object of the online system or a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action.

The user identification module 306 identifies the users that match the targeting criteria as being eligible to be presented with the ad. The user identification module 306 may query the targeting criteria associated with the ad in the user profile store 202, action long 208, and/or edge store 210 to identify matches and thereby to identify users that are associated with the matches. Continuing with the previous example, the user identification module 306 identifies the female users who are located in California and have interacted with the advertiser's page in the past 180 days as the eligible users to be presented with the ad.

For an ad of an ad campaign and eligible users identified for the ad, the bid price determination module 308 determines bid prices to be associated with the ad based on the delivery parameters associated with the ad campaign and user cost models of the eligible users. A bid price associated with the ad is used for bidding in an auction for an impression opportunity of presenting an ad to an eligible user. Specifically, for each eligible user, the bid price determination module 308 determines a bid price by maximizing a value that the advertiser expects to derive from the ad campaign. The bid price determination module 308 determines the bid prices for the eligible users such that an advertiser's budget is spent optimally and the amount of value that the advertiser receives from the ad campaign is maximized. Since it costs different amount to reach different users and the value that an advertiser derives from impressions of an ad is not constant, the bid price determination module 308 accounts for these variances in cost and in value when determining the bid prices to be associated with an ad of an ad campaign to maximize the value derived by the advertiser when meeting the advertiser's goal.

When determining bid prices for an ad of an ad campaign, the bid price determination module 308 considers delivery parameters associated with the ad campaign such as a budget, a target reach amount (i.e., a number of users to whom an ad is presented) in a time interval, a target impression amount (i.e., a number of times an ad is presented) in a time interval, a frequency cap, and a value curve. Typically, value that an advertiser derives from presenting an ad to a user declines after several impressions of the ad to the user. An example value curve 408 is illustrated in FIG. 4B. In the illustrated example, the advertiser specifies that the frequency cap is 6. An ad will be presented to a user for at most 6 times. The advertiser provides a value curve from which a first value amount (R) for a reach impression and a second value amount (I) for a non-reach impression can be determined. The bid price determination module 308 also receives adjustment input from the ad performance evaluation module 314 and adjusts the value curve accordingly. For example, the ad performance evaluation module 314 adjusts a first value amount for a reach impression and a second value amount for each non-reach impression as further described below. In some embodiments, the bid price determination module 308 can determine the first value amount and the second value amount using the value curve and one or more other delivery parameters such as a budget, a time interval, a target reach amount, a target impression amount, and the like.

For an eligible user, when determining a bid price to be associated with an ad for a user, the bid price determination module 306 evaluates an amount of excess value that an advertiser will derive from presenting the ad. An advertiser can derive value only if an ad wins an ad auction; however, the advertiser derives lesser excess value if the bid price winning the auction is higher. Excess value is the amount of value that an advertiser derives from an ad impression minus the cost. As described herein, costs to advertisers for presenting ads are assumed to equal to bid prices. One of ordinary skill in the art would appreciate that costs to advertisers may additionally include penalty or other amount charged by the online system 140. The bid price determination module 306 evaluates an amount of excess value by estimating a number of times that the ad is to be presented to a user at a given bid price and a probability of winning ad auctions for the number of times with the bid price. The bid price determination module 306 evaluates the probability of winning auction(s) based on a user cost model of the eligible user and one or more delivery parameters associated with the ad such as a budget, a target reach amount in a time interval, a frequency cap, and a value curve that specifies a value amount that an advertiser expects to derive from ad impressions.

For the eligible user, given a bid price B, the probability of winning one or more auction(s) for one or more impression opportunities can be determined according to Equation (1):

$${P}_{0} = C ( N , 0 ) * {( 1 - P )}^{N} \\ {P}_{1} = C ( N , 1 ) {P}^{1} * C ( N , N - 1 ) {( 1 - P )}^{N - 1} \\ {P}_{2} = C ( N , 2 ) {P}^{2} * C ( N , N - 2 ) {( 1 - P )}^{N - 2} \\ … \\ {P}_{X} = C ( N , X ) {P}^{X} * C ( N , N - X ) {( 1 - P )}^{N - X} \\ {P}_{M} = C ( N , M ) {P}^{M} * C ( N , N - M ) {( 1 - P )}^{N - M} , \qquad ( 1 )$$

where P is a probability of winning an auction for an impression opportunity for the eligible user, X is a non-negative integer having a value in the range of (0, M) indicating a total number of times when the ad is to be presented to a user, P_{X} is a probability of winning X numbers of auctions for X numbers of impression opportunities for the eligible user, M is a frequency cap that the ad is to be presented to the user, N is the number of possible impression opportunities available for presenting ads for the eligible user during the time interval, and C(N,X) is a combination of selecting X from a collection of N.

For an eligible user, given a bid price B, the bid price determination module 306 determines the probability P of a given number of impressions using the user cost model. In some embodiments, the probability of winning an auction is determined as the percentile of the bid price B that is identified using the user cost model multiplied by a coefficient (e.g., 1%). For example, the probability of a 50th percentile bid price winning an auction is 0.5, the probability of a 80th percentile bid price winning an auction is 0.8.

For an eligible user, the bid price determination module 306 predicts a number of impression opportunities that will be available during a time interval associated with an ad campaign, for example, based on information associated with the eligible user. The bid price determination module 306 considers information such as previously completed ad auctions for this eligible user, a number of ads presented to the user in a time period, ad requests received from the user during a time period, and the like. The information associated with the eligible user can be obtained from the user profile store 202, action log 208, edge store 210, and/or ad auction store 310.

The bid price determination module 308 evaluates an amount of excess value that an advertiser will derive from presenting the ad according to Equations (2)-(5) as further described herein. For an eligible user, the bid price determination module 308 determines a bid price to be associated with an ad by maximizing an amount of excess value that the advertiser will derive from the ad campaign. The bid price determination module 308 predicts a likelihood (Px) of presenting the ad for a number of times (X) at the bid price and calculates the amount of expected value that the advertiser will derive. A total amount of value that the advertiser derives from presenting an ad to an eligible user for a number of times X can be determined according to Equation (2):

Value to Advertiser=R+(X−1)*I (2),

where R is the amount of value that the advertiser derives from each reach impression, I is the amount of value that the advertiser derives from each non-reach impression, and X is a non-negative integer having a value in the range of (0, M) indicating the total amount of times the ad is to be presented to a user.

The cost to an advertiser for presenting an ad to a user can be determined according to Equation (3):

Cost to Advertiser=X*B (3),

where X is a non-negative integer having a value in the range of (0, M) indicating the total amount of times the ad is to be presented to a user, and B is the bid price to be associated with the ad, that is determined by the bid price determination module 308.

Accordingly, the excess value derived by the advertiser from presenting the ad to the user for X times can be determined according to Equation (4):

Excess Value=R+(X−1)*I−X*B (4),

where R, X, I, and B are parameters as previously described with respect to Equations (1)-(3).

The excess value that the advertiser expects to derive from presenting the ad to the user for X times can be determined according to Equation (5):

Expected Value=P_{X}*Excess Value=C(N,X)P^{X}*C(N,N−X)(1−P)^{N-X}*(R+(X−1)*I−X*B) (5),

where P, R, X, I, and B are parameters as previously described with respect to Equations (1)-(3). For each eligible user, the bid price determination module 308 determines a bid price by maximizing an amount of expected value that the advertiser will derive according to Equation (5).

The bid price determination module 308 determines bid prices for all eligible users to meeting the advertiser's goal (e.g., reaching a target number of users during a time interval, presenting the ad for a target number of times during a time interval, etc.) Since it costs differently to reach different users and the advertiser derives more value from a reach impression than from a non-reach impression, determining bid prices and a total number of impressions across users optimizes spending an advertiser's budget for an ad campaign. For example, to maximize excess value an advertiser derives, users who tend to have higher cost to win an impression according to the cost model may tend to have a bid that is likely to present fewer ads (e.g., just one) relative to users that are less expensive to win a bid. The bid price determination module 308 provides the determined prices associated with an ad for eligible users to the ad auction module 310. In one embodiment, the bid price determination module 306 uses an average bid price as the initial value for the bid price B for an eligible user when determining the bid prices and a total number of impressions for eligible users.

The ad auction module 310 processes ad requests and manages ad auctions. The ad auction module 310 receives ad requests from user devices for ads and identifies eligible ads to fulfill the ad requests. The identified eligible ads are associated with bid prices. For an impression opportunity corresponding to an ad request, the ad auction module 310 includes identified ads associated with bid prices in an auction. The ad auction module 310 selects an ad from the ads included in the auction for presentation in the impression opportunity. The selection process may use a variety of auction types such as a highest-bid auction, a Vickrey-Clarke-Groves auction, or another type of auction. As one example, the ad auction module 310 ranks ads included in an ad auction based on their associated bid prices and selects a highest ranked ad for presentation via the impression opportunity. The ad auction module 120 provides information associated with ad auctions in the ad auction store 312 for storage. The ad auction module 120 further communicates information associated with ad auctions to the ad performance evaluation module 135 for evaluation thereby to increase the likelihood that an advertiser's goals are satisfied.

The ad auction store 312 stores information associated with historical ad auctions that have been completed. Example information includes information identifying an ad selected from a completed auction, a bid price associated with the selected ad, an amount charged to an advertiser providing the selected ad, targeting criteria associated with the selected ad, delivery parameter associated with the selected ad, and the like.

The ad performance evaluation module 314 evaluates performance of ad campaigns by using information received from the ad auction module 120 and delivery parameters associated with ad campaigns. In particular, the ad performance evaluation module 314 evaluates whether ad campaigns' performances track desired paces. Information received from the ad auction module 120 includes an ad of an ad campaign that has been presented to a user, a bid price associated with the ad, a number of times that the ad has been presented to the user, and the like. For an ad campaign, the ad performance evaluation module 314 tracks a number of impressions of an ad of the ad campaign, a number of reach of an ad of the ad campaign, a budget spending, and the like. The ad performance evaluation module 314 determines a reach (or impression) performance by comparing the number of reach (or impression) achieved using an amount since the start of an ad campaign to an advertiser's requirement (i.e., target reach (or impression) amount that needs to be reached using the budget within the time duration.) When the reach (or impression) performance does not track desired pace required by the advertiser, the ad performance evaluation module 314 adjusts the value curve. For example, the ad performance evaluation module 314 adjusts at least one of a first value amount for a reach impression and a second value amount for a non-reach impression. The ad performance evaluation module 314 can adjust a first value amount for a reach impression and/or a second value amount for a non-reach impression based on the reach (impression) performance. For example, the first value amount for a reach impression and/or the second amount for a non-reach impression are reduced if the ad performance evaluation module 314 determines that the target reach amount cannot be met using the budget within the time interval of the ad campaign. The first value amount for a reach impression and/or the second amount for a non-reach impression are increased if the ad performance evaluation module 314 determines that the target reach amount will be met using the budget earlier than an expiration of the time interval of the ad campaign. The ad performance evaluation module 314 provides the adjusted value curve (e.g., an adjusted amount of a reach impression and/or an adjusted amount of a non-reach impression) to the bid price determination module 308. Responsive to receiving the adjusted value curve, the bid price determination module 308 calculates adjusted bid prices using the adjusted value curve received from the ad performance evaluation module 314.

### User-Level Bidding

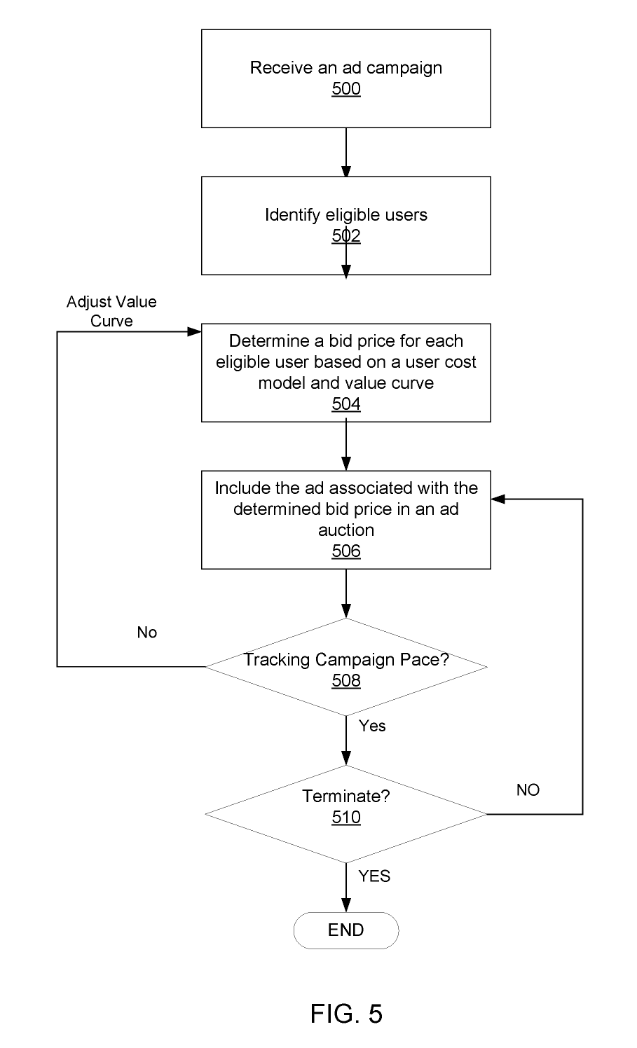

FIG. 5 is a flowchart of a method for determining bid prices based at least on user cost models for presenting ads from an ad campaign. In various embodiments, the steps described in conjunction with FIG. 5 may be performed in different orders. Additionally, different and/or additional steps than those described in conjunction with FIG. 0.5 may be performed in some embodiments.

The online system 140 receives 500 an ad campaign from an advertiser. The ad campaign includes one or more ads for presentation to users of the online system 140. The ad campaign is associated with one or more delivery parameters that describe an advertiser's goal of an ad campaign as well as the advertiser's restrictions on delivery of the ad campaign. For example, the ad campaign is associated with a budget, one or more targeting criteria, a target reach amount (or a target impression amount), a time interval during which an ad is eligible for presentation to users, a start date and time, value that an advertiser expects to derive from the ad campaign (e.g., a value curve, a value amount (R) it expects to derive from a reach impression, a value amount (I) it expects to derive from a non-reach impression, etc.), a frequency cap (M), and the like. The online system 140 presents one or more ads from the ad campaign on behalf of the advertiser.

The online system 140 identifies 502 eligible users based on the targeting criteria associated with the ad campaign. The eligible users having characteristics that match the targeting criteria. The online system 140 determines 504 a bid price (B) to be associated with the ad based at least on a user cost model and a value curve. The user cost model describes a distribution of bid prices associated with ads that have been presented to the user. From the value curve, the online system 140 can identify an amount of value returned to the advertiser each time that an ad is presented to a user. For each eligible user, the online system 140 determines the bid price (B) by maximizing a value that the advertiser expects to drive from the ad campaign. For a given price, the value that the advertiser expects to derive from the ad campaign varies with the number of (X) impressions that the ad is to be presented to the user. The online system 140 determines the bid prices for the eligible users such that an advertiser's budget is spent optimally and a value that the advertiser expects to derive from the ad campaign is maximized. Specifically, the online system 140 evaluates an amount of excess value that an advertiser expects to derive from presenting the ad to an eligible user.

The online system 140 predicts a number (N) of impression opportunities that will be available during a time interval associated with an ad campaign, for example, based at least on information associated with the eligible user. The online system 140 calculates the excess value that the advertiser expects to derive from presenting an ad at bid price B to the eligible user for X times according to Equation (5) and determines the bid price B by maximizing the excess value that the advertiser expects to derive. The bid price determination module 308 determines the bid prices for different users while meeting the advertiser's goal (e.g., reaching a target number of users during a time interval, presenting the ad for a target number of times during a time interval, etc.) In one embodiment, the bid price determination module 306 uses an average bid price as the initial value for the bid price B for an eligible user when determining the bid prices.

Responsive to receiving a request for an ad from a client device of the eligible user, the online system 140 includes 506 the ad associated with the determined bid price (B) in an ad auction. The online system 140 selects an ad from the ads that are included in the ad auction for presentation to the eligible user. The online system 140 may update the user cost model for the user when the auction completes. Alternatively, the online system 140 updates user cost models periodically. The online system 140 further stores information associated with the ad auction.

The online system 140 evaluates 508 whether the ad campaign's performance tracks the campaign pace, for example, by using information associated with ad auctions associated with the ad campaign and delivery parameters associated with the ad campaign. For example, the online system 140 determines a reach (or impression) performance by comparing the number of reach (or impression) achieved using an amount that has spent since the start of an ad campaign to the advertiser's requirement (i.e., a target reach (or impression) amount that needs to be reached using the budget within the time duration). When the reach (or impression) performance is not as required by the advertiser, the online system 140 adjusts the value curve. For example, the online system 140 adjusts at least one of a value amount (R) of a reach impression and a value amount (I) of a non-reach impression based on the evaluation. If the online system 140 determines that the performance of the ad campaign does not track the ad campaign's pace, the online system 140 re-calculates a bid price for each eligible user using the updated value curve from which an updated amount of a reach impression and/or an updated value amount of a non-reach impression can be determined.

The online system 140 determines 510 whether or not to terminate the ad campaign. For example, when the budget is exhausted, when the time duration is reached, or when the target reach amount is reached, the online system 140 stops presenting ads from the ad campaign. Otherwise, the online system 140 continues presenting ads of the ad campaign to the eligible users according to the determined bid prices and number of impressions.

### Other Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
receiving, by an online system, an advertisement (“ad”) campaign associated with a set of delivery parameters, the ad campaign including an ad and the set of delivery parameters including one or more targeting criteria, a target reach amount, a value curve and a frequency cap, the value curve specifying a value amount of each impression as a function of a number times of the ad being presented to a user;
identifying eligible users to receive an ad based on the one or more targeting criteria, the eligible users having characteristics that match the one or more targeting criteria;
for each eligible user, determining a bid price for the advertisement based on an expected value of an expected number of impressions of the ad to be presented to the eligible user, the expected number of impressions being determined based on the bid price applied to a user cost model comprising a distribution of bid prices of prior ads that have been presented to the eligible user;
receiving a request for ad from a user device of an eligible user; and
in response to receiving the request for ad, including the ad associated with the bid price determined for the eligible user in an ad auction.

2. The method of claim 1, wherein the determining the bid price based on an expected value of an expected number of impressions provided to the eligible user comprises:
predicting a number of impression opportunities available during a time interval associated with the ad campaign, the time interval included in the set of delivery parameters;
calculating an amount of expected value of the expected number of impressions based on the bid price, the user cost model, and the value curve, the expected value being the value of presenting the ad at the bid price for the expected number of impressions based on the user cost model
determining the bid price that maximizes the expected value of the expected number of impressions.

3. The method of claim 2, wherein the calculating the amount of expected value comprises:
determining a probability of winning an auction using the bid price and the user cost model of the eligible user; and
determining a probability of winning auctions for the expected number of impressions based on the probability of winning an auction and a combination of selecting the quantity of the set of impressions from the number of impression opportunities;
wherein the amount of expected value derived from presenting the ad to the eligible user is an amount of value derived from the set of impressions of the ad to the user weighted by the probability of winning auctions for the quantity of the set of impressions.

4. The method of claim 3, further comprising: determining the amount of value derived for each impression according to the value curve.

5. The method of claim 4, wherein the set of impressions comprises a first set of reach impressions and a second set of non-reach impressions, and the amount of value derived from the set of impressions of the ad to the user is a sum of a first amount derived from the first set of reach impressions and a second amount derived from the second set of non-reach impressions.

6. The method of claim 5, wherein the set of impressions is a zero set, and the amount of value derived from the set of impressions is zero.

7. The method of claim 5, wherein the set of impressions comprises at least one impressions, wherein the first amount derived is a first difference between the first value amount of a reach impression minus the bid price, and wherein the second amount derived is the quantity of set of impressions minus one times a second difference between the second value amount of a non-reach impression minus the bid price.

8. The method of claim 2, wherein the step of maximizing the expected value of the expected number of impressions comprises:
receiving an initial bid price;
determining an initial probability of winning ad auctions for the expected number of impressions using the initial bid price based on the user cost model associated with the eligible user; and
adjusting the initial bid price to the bid price to maximize the amount of expected value derived from presenting the ad to the eligible user.

9. The method of claim 8, wherein the initial bid price is an average of bid prices associated with ads that have been presented to the user.

10. The method of claim 1, further comprising:
evaluating whether the ad campaign tracks a pace by comparing an actual reach amount since a start of the ad campaign to the target reach amount, a spending amount of the budget to the budget, and a time period since the start of the ad campaign to a time duration associated with the ad campaign; and
adjusting the value curve by decreasing at least one of a first value amount of a reach impression and a second value amount of a non-reach impression responsive to the evaluation indicating that the target reach amount cannot be met using the budget within the time duration associated with the ad campaign.

11. The method of claim 1, further comprising:
evaluating whether the ad campaign tracks a pace by comparing an actual reach amount since a start of the ad campaign to the target reach amount, a spending amount of the budget to the budget, and a time period since the start of the ad campaign to a time duration associated with the ad campaign; and
adjusting the value curve by increasing at least one of the first value amount of a reach impression and a second value amount of a non-reach impression responsive to the evaluation indicating that the target reach amount will be met using the budget earlier than an expiration of the time duration associated with the ad campaign.

12. The method of claim 1, further comprising:
selecting an ad for presentation to the user from a set of ads included in the auction; and
providing the selected ad to the eligible user for presentation.

13. A computer program product comprising a computer-readable storage medium having instructions encoded thereon that, when executed by a processor, cause the processor to perform:
receiving, by an online system, an advertisement (“ad”) campaign associated with a set of delivery parameters, the ad campaign including an ad and the set of delivery parameters including one or more targeting criteria, a target reach amount, a value curve and a frequency cap, the value curve specifying a value amount of each impression as a function of a number times of the ad being presented to a user;
identifying eligible users to receive an ad based on the one or more targeting criteria, the eligible users having characteristics that match the one or more targeting criteria;
for each eligible user, determining a bid price for the advertisement based on an expected value of an expected number of impressions of the ad to be presented to the eligible user, the expected number of impressions being determined based on the bid price applied to a user cost model comprising a distribution of bid prices of prior ads that have been presented to the eligible user;
receiving a request for ad from a user device of an eligible user; and
in response to receiving the request for ad, including the ad associated with the bid price determined for the eligible user in an ad auction.

14. The computer program product of claim 13, wherein the determining the bid price based on an expected value of an expected number of impressions provided to the eligible user comprises:
predicting a number of impression opportunities available during a time interval associated with the ad campaign, the time interval included in the set of delivery parameters;
calculating an amount of expected value of the expected number of impressions based on the bid price, the user cost model, and the value curve, the expected value being the value of presenting the ad at the bid price for the expected number of impressions based on the user cost model
determining the bid price that maximizes the expected value of the expected number of impressions.

15. The computer program product of claim 14, wherein the calculating the amount of expected value comprises:
determining a probability of winning an auction using the bid price and the user cost model of the eligible user; and
determining a probability of winning auctions for the expected number of impressions based on the probability of winning an auction and a combination of selecting the quantity of the set of impressions from the number of impression opportunities;
wherein the amount of expected value derived from presenting the ad to the eligible user is an amount of value derived from the set of impressions of the ad to the user weighted by the probability of winning auctions for the quantity of the set of impressions.

16. The computer program product of claim 15, further comprising: determining the amount of value derived for each impression according to the value curve.

17. The computer program product of claim 16, wherein the set of impressions comprises a first set of reach impressions and a second set of non-reach impressions, and the amount of value derived from the set of impressions of the ad to the user is a sum of a first amount derived from the first set of reach impressions and a second amount derived from the second set of non-reach impressions.

18. The computer program product of claim 17, wherein the set of impressions is a zero set, and the amount of value derived from the set of impressions is zero.

19. The computer program product of claim 17, wherein the set of impressions comprises at least one impressions, wherein the first amount derived is a first difference between the first value amount of a reach impression minus the bid price, and wherein the second amount derived is the quantity of set of impressions minus one times a second difference between the second value amount of a non-reach impression minus the bid price.

20. The computer program product of claim 15, wherein the step of maximizing the expected value of the expected number of impressions comprises:
receiving an initial bid price;
determining an initial probability of winning ad auctions for the expected number of impressions using the initial bid price based on the user cost model associated with the eligible user; and
adjusting the initial bid price to the bid price to maximize the amount of expected value derived from presenting the ad to the eligible user.

21. The computer program product of claim 20, wherein the initial bid price is an average of bid prices associated with ads that have been presented to the user.

22. The computer program product of claim 14, wherein the computer-readable storage medium have instructions that cause the processor to further perform:
evaluating whether the ad campaign tracks a pace by comparing an actual reach amount since a start of the ad campaign to the target reach amount, a spending amount of the budget to the budget, and a time period since the start of the ad campaign to a time duration associated with the ad campaign; and
adjusting the value curve by decreasing at least one of a first value amount of a reach impression and a second value amount of a non-reach impression responsive to the evaluation indicating that the target reach amount cannot be met using the budget within the time duration associated with the ad campaign.

23. The computer program product of claim 14, wherein the computer-readable storage medium have instructions that cause the processor to further perform:
evaluating whether the ad campaign tracks a pace by comparing an actual reach amount since a start of the ad campaign to the target reach amount, a spending amount of the budget to the budget, and a time period since the start of the ad campaign to a time duration associated with the ad campaign; and
adjusting the value curve by increasing at least one of the first value amount of a reach impression and a second value amount of a non-reach impression responsive to the evaluation indicating that the target reach amount will be met using the budget earlier than an expiration of the time duration associated with the ad campaign.

24. The computer program product of claim 13, wherein the computer-readable storage medium have instructions that cause the processor to further perform:
selecting an ad for presentation to the user from a set of ads included in the auction; and
providing the selected ad to the eligible user for presentation.
